(19) United States
(12) Patent Application Publication
(10) Pub. No.: US 2009/0201243 A1
(43) Pub. Date: Aug. 13, 2009

(54) METHODS AND SYSTEMS INVOLVING DIURNAL COMPUTING

(75) Inventors: Allen K. Bates, Tucson, AZ (US); Nils Haustein, Soergenloch (DE); Craig A. Klein, Tucson, AZ (US); Daniel J. Winarski, Tucson, AZ (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/027,539

(22) Filed: Feb. 7, 2008

(51) Int. Cl. G09G 3/36

(52) U.S. Cl. 345/102

(57) ABSTRACT

A method for controlling a computer system comprising, determining an ambient light level, starting a lighting device operative to illuminate an input device responsive to determining that the ambient light level is below a threshold value, and stopping the lighting device responsive to determining that the ambient light level is above the threshold value.

### BACKGROUND OF THE INVENTION

1. Field of the Invention

This invention relates generally to a methods and systems involving diurnal computing.

2. Description of Background

Computer systems often include displays and input devices such as, for example, keyboards. Some systems include lights that may be used to illuminate input devices. Displays also include settings that may be adjusted to compensate for ambient light in an environment.

### SUMMARY OF THE INVENTION

The shortcomings of the prior art are overcome and additional advantages are achieved through an exemplary method for controlling a computer system, including determining an ambient light level, starting a lighting device operative to illuminate an input device responsive to determining that the ambient light level is below a threshold value, and stopping the lighting device responsive to determining that the ambient light level is above the threshold value.

An exemplary embodiment of a computer system includes a lighting device operative to illuminate an input device, and a processor determine an ambient light level, wherein the processor is further operative to start the lighting device responsive to determining that the ambient light level is below a threshold level, and stop the lighting device responsive to determining that the ambient light level is above the threshold level.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates an exemplary embodiment of a computer system.

FIG. 2a illustrates a front view of an exemplary embodiment of a computer system.

FIG. 2b illustrates a rear view of the exemplary embodiment of a computer system of FIG. 2a.

FIG. 3 illustrates block diagram of an exemplary method of operation of the computer system of FIG. 1.

The detailed description explains the preferred embodiments of the invention, together with advantages and features, by way of example with reference to the drawings.

### DETAILED DESCRIPTION OF THE INVENTION

Methods and systems involving diurnal computing are provided.

In this regard, diurnal computing refers to computing during daily cycles particularly in relation to ambient light available during different times of the day.

Computer systems, particularly mobile computer systems, may be used in locations that have differing amounts of ambient light based, in part, on the time of day the computer system is being used. Some computer systems include lighting devices that illuminate input devices such as, for example, keyboards in the system. The light from the lighting device assists a user in operating the input devices. Computer systems also include displays, such as, for example, liquid crystal displays (LCDs) that have backlighting that may be adjusted for viewing. Different ambient light levels may make some backlighting settings uncomfortable. It is desirable for a computer system to determine ambient light levels and adjust settings of the display and to turn lighting devices on and off depending on the determined ambient light levels.

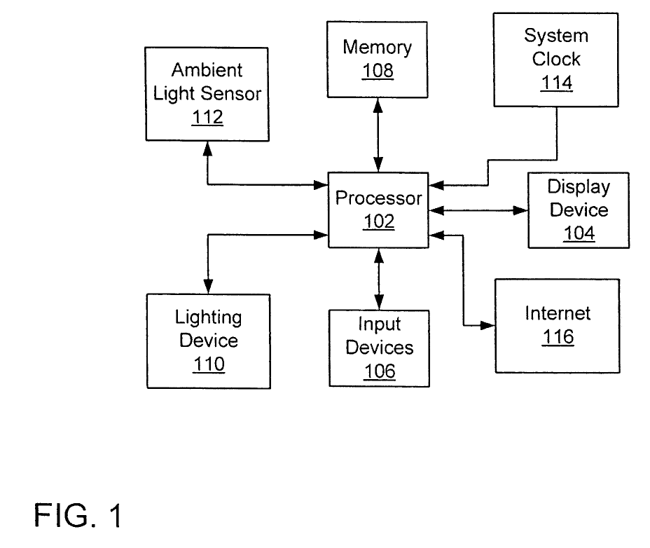

FIG. 1 illustrates an exemplary embodiment of a block diagram of a computer system. The computer system includes a processor 102 communicatively linked to the Internet 116, a memory 108, a system clock 114, and an input device 106. The input device 106 may include, for example, a keyboard, a mouse, or other similar input devices. The processor 102 is also communicatively linked to a display device 104. The display device 104 may, for example, be a LCD display, or a cathode ray tube type display. An ambient light sensor 112, such as, for example, a photoresistor, a photoreceiver, and a photoreceptor diode is communicatively linked to the processor 102. A lighting device 110 such as, for example, a light emitting diode (LED) is also communicatively linked to the processor 102.

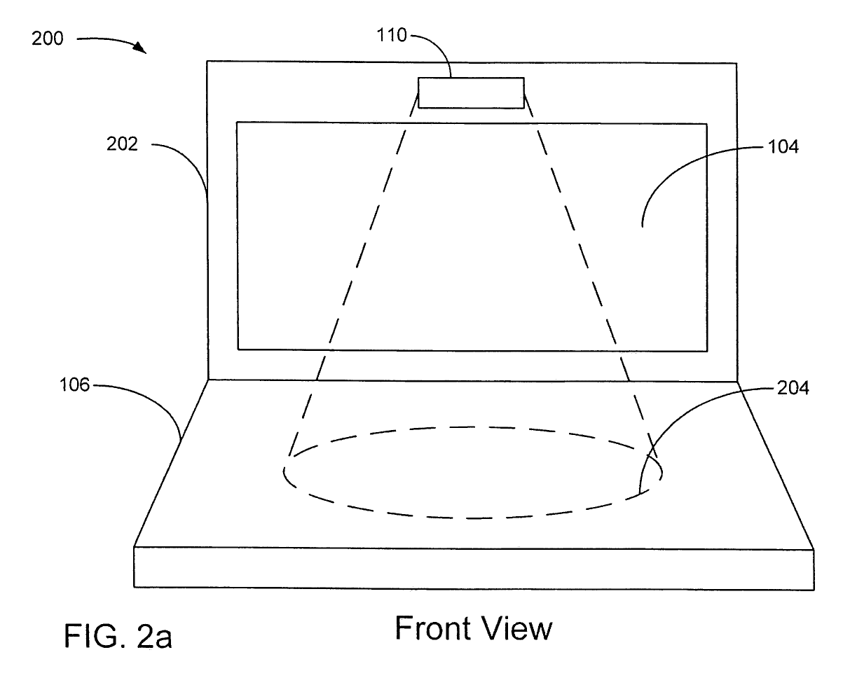

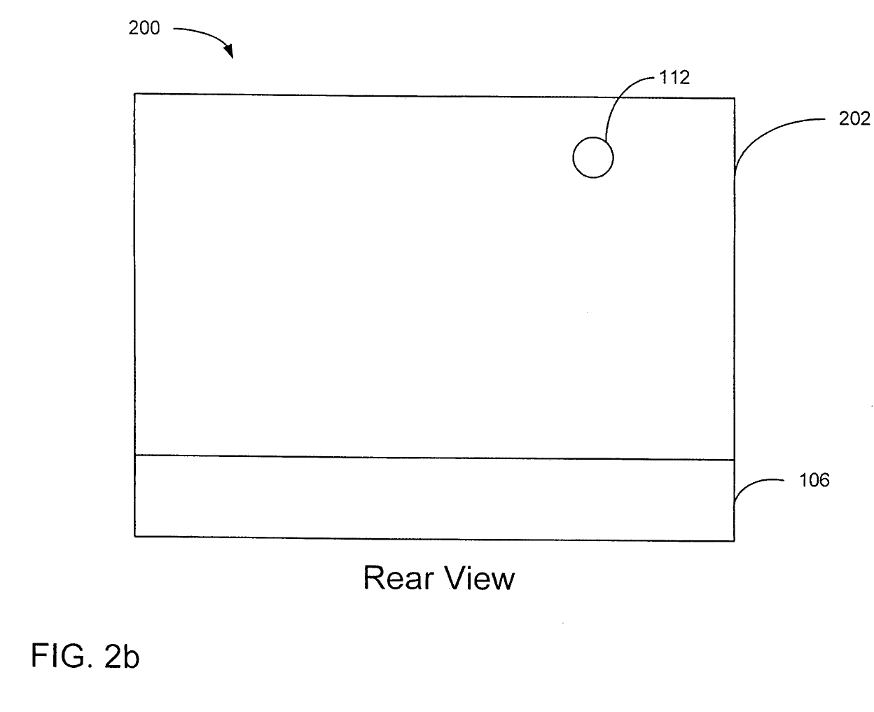

FIG. 2a illustrates a front view of an exemplary embodiment of a computer system 200. The embodiment of the computer system 200 is a portable computer system including the display device 104 in a housing portion 202. The input device 106 is a keyboard that may be, in operation, illuminated by the lighting device 110, located in the housing portion 202.

FIG. 2b illustrates a rear view of the computer system 200 including an ambient light sensor 112. The ambient light sensor 112 may be located in a position such that light from the display device 104 does not appreciably effect the sensing of ambient light in the environment.

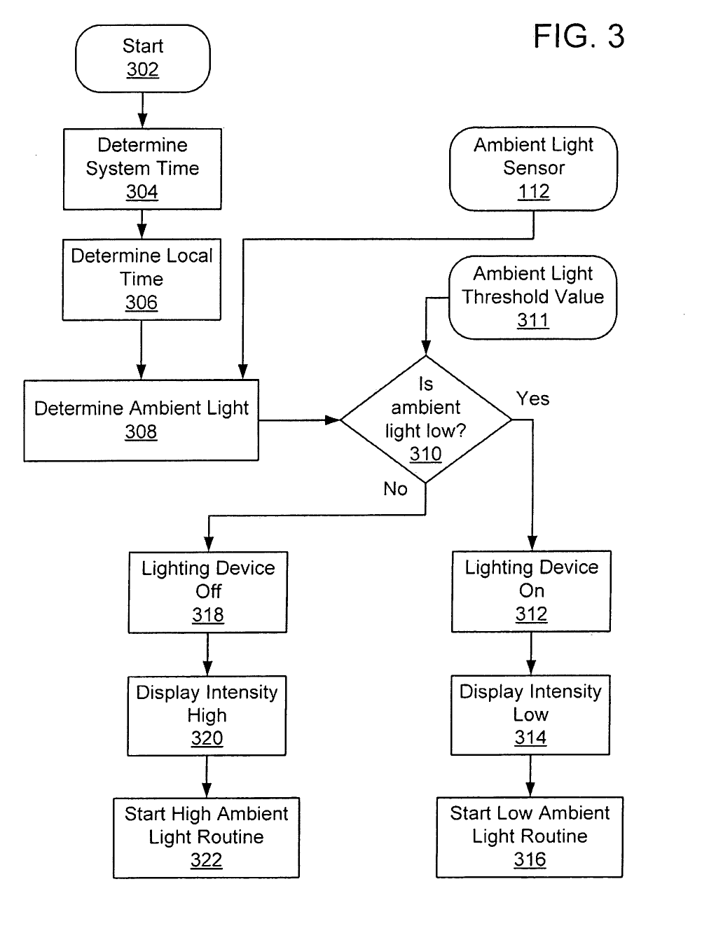

FIG. 3 illustrates a block diagram of an exemplary method of operation of the system 200. The method starts in block 302. The start may be initiated, for example, upon a boot-up of the system 200, an exit from a “sleep mode” of the system 200, or during operation of the system 200. In block 304, the system time is determined from the system clock 114 (of FIG. 1). The local time may be determined in block 306. The local time may be determined by a user input designating the location of the system 200, or from another source, such as, for example, the Internet 116 using the network time protocol (NTP). The determination of the local time allows the processor 102 to determine whether the system 200 is operating at night or during the day. The determination allows the processor 102 to estimate the ambient light from sunlight that may be present in the system 200 operating environment.

The ambient light sensor 112 may also send a signal to the processor 102 that may be used to determine the ambient light level in the system 200 environment. The signal from the ambient light sensor 112 may be used with, or independently to determine ambient light in block 308.

The determined ambient light may be compared to an ambient light threshold value 311 to determine if the ambient light is low (below the ambient light threshold value 311) in block 310. If the ambient light is low, the lighting device 110 may be turned on in block 312 to illuminate the input device 106. Additionally, the display device 104 may be set to a low ambient light setting in block 314. The low ambient light setting may, for example, be a lower amount of backlighting than would be used in a brighter ambient light environment. In block 316, a low ambient light routine may be started.

A low ambient light routine may, for example, be a number of macros defined by a user that initiate particular settings desirable in low ambient light, or during a particular local time. Additionally, a low light routine may include starting particular programs that are desirable during operation in low ambient light environments such as, for example, particular types of music, opening particular Internet websites, or starting productivity software.

If the ambient light is not low, and is above the ambient light threshold value 311, the lighting device 110 may be turned off in block 318. The display device 104 may be set to a high ambient light setting in block 320. A high ambient light routine may be started in block 322. The high ambient light routine may be similar to the low ambient light routine, however it includes settings desirable in a high ambient light environment.

The use of local and system times along with the ambient light sensor, offer the system 200 the ability to operate with diurnal settings reflecting operating times and ambient light in the operating environment. These elements offer flexibility and ease of use to the system 200.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for controlling a computer system comprising:
determining an ambient light level;
starting a lighting device operative to illuminate an input device responsive to determining that the ambient light level is below a threshold value; and
stopping the lighting device responsive to determining that the ambient light level is above the threshold value.

2. The method of claim 1, wherein the method further comprises setting a display device to a low ambient light setting in further response to determining that the ambient light level is below the threshold value.

3. The method of claim 1, wherein the method further comprises setting a display device to a high ambient light setting in further response to determining that the ambient light level is above the threshold value.

4. The method of claim 1, wherein the method further comprises starting a low ambient light routine in further response to determining that the ambient light level is below the threshold value.

5. The method of claim 1, wherein the method further comprises starting a high ambient light routine in further response to determining that the ambient light level is above the threshold value.

6. The method of claim 1, wherein the ambient light level is determined from a signal from an ambient light sensor operative to sense an ambient light level.

7. The method of claim 1, wherein the ambient light level is determined from a system time of the computer system.

8. The method of claim 1, wherein the ambient light level is determined by determining a local time defined by a location of the computer system.

9. The method of claim 1, wherein the method further comprises determining an ambient light level responsive to starting the computer system.

10. A computer system comprising:
a lighting device operative to illuminate an input device; and
a processor determine an ambient light level, wherein the processor is further operative to start the lighting device responsive to determining that the ambient light level is below a threshold level, and stop the lighting device responsive to determining that the ambient light level is above the threshold level.

11. The system of claim 10, wherein the system further comprises a display device, and wherein the processor is further operative to set the display device to a low ambient light setting in further response to determining that the ambient light level is below the threshold value.

12. The system of claim 10, wherein the system further comprises a display device, and wherein the processor is further operative to set the display device to a high ambient light setting in further response to determining that the ambient light level is above the threshold value.

13. The system of claim 10, wherein the processor is further operative to start a low ambient light routine in further response to determining that the ambient light level is below the threshold value.

14. The system of claim 10, wherein the processor is further operative to start a high ambient light routine in further response to determining that the ambient light level is above the threshold value.

15. The system of claim 10, wherein, the system further comprises an ambient light sensor operative to sense an ambient light level and output the ambient light level signal to the processor, wherein the processor is further operative to determine the ambient light level from the signal.

16. The system of claim 10, wherein the ambient light level is determined from a system time of the computer system.

17. The system of claim 10, wherein the ambient light level is determined by determining a local time defined by a location of the computer system.

18. The system of claim 10, wherein the processor is further operative to determine the ambient light level responsive to starting computer system.
